(19) United States
(12) Patent Application Publication
(10) Pub. No.: US 2025/0003892 A1
(43) Pub. Date: Jan. 2, 2025

(54) X-RAY INSPECTION APPARATUS, ARTICLE INSPECTION SYSTEM, X-RAY IMAGE FORMING APPARATUS, AND ARTICLE PROCESSING SYSTEM

(71) Applicant: ANRITSU CORPORATION, Kanagawa (JP)

(72) Inventors: Takeshi YAMAZAKI, Kanagawa (JP); Kengo ODA, Kanagawa (JP); Ryohei ISHIKAWA, Kanagawa (JP); Naoya SAITO, Kanagawa (JP)

(21) Appl. No.: 18/753,255

(22) Filed: Jun. 25, 2024

(30) Foreign Application Priority Data
Jun. 29, 2023 (JP) 2023-106878

(51) Int. Cl. G01N 23/04; G06T 5/50

(52) U.S. Cl. CPC G01N 23/04; G06T 5/50; G01N 2223/1016; G06T 2207/10116; G06T 2207/20224

(57) ABSTRACT

There is provided an X-ray inspection apparatus including: an X-ray inspection unit and an inspection processing unit that execute an image process on X-ray transmission image data in a plurality of energy regions to generate an inspection image and inspect an inspection object; a display panel for displaying an inspection result; a display image generation portion for executing an image process on the X-ray transmission image data in the plurality of energy regions to generate a display image as a candidate image in which an image brightness of the inspection object is visually different from an image brightness of the inspection image used in the inspection processing unit; and a display control portion for causing the display panel to display the inspection result and the display image different from the inspection image.

### TECHNICAL FIELD

The present invention relates to an X-ray inspection apparatus, an article inspection system, and an X-ray image forming apparatus, and particularly relates to an X-ray inspection apparatus, an article inspection system, and an X-ray image forming apparatus capable of generating an X-ray image appropriate for a purpose such as an article inspection based on transmission image data of X-rays of a plurality of different energy regions.

### BACKGROUND ART

An X-ray inspection apparatus is known in which X-rays of a plurality of different energy regions are emitted to an article to acquire transmission image data having a brightness variation according to a distribution of a transmission amount, and a predetermined image process is performed to inspect a quality of the article with high accuracy by making a difference in brightness between portions such as containing foreign matter or packaging defects.

For example, in an X-ray inspection apparatus disclosed in Patent Document 1, a transmission image in which a foreign matter is emphasized is generated by a subtraction process, and the presence or absence of the foreign matter is inspected and displayed on a display unit, so that an operator can grasp an inspection situation.

In addition, as in Patent Document 2, a display unit can be provided at a work location for post-processing an article after an inspection, and can display a work instruction including a transmission image to an operator.

### RELATED ART DOCUMENT

### Patent Document

[Patent Document 1] JP-A-2018-141736
[Patent Document 2] JP-A-2017-138193

### DISCLOSURE OF THE INVENTION

### Problem that the Invention is to Solve

Meanwhile, in the X-ray inspection apparatus, the system, and the like in the related art, for example, as an image processing technique for increasing detection accuracy of a foreign matter contained in an article is advanced, a portion having a high possibility of the foreign matter is emphasized and a brightness is remarkable, and inspection performance of the foreign matter can be improved, but the brightness variation tends to be ambiguous in a portion having a low possibility of the foreign matter.

That is, an X-ray transmission image of the article itself obtained as a result of an image process for accurately detecting the foreign matter is not useful for an operator who performs additional inspection, processing, or the like because it is difficult to obtain information for visually grasping a situation of a target object even by careful observation.

For example, in a case where a removal work of a residue such as a bone remaining in the article is performed as the additional processing while checking a position of the residue by looking at the transmission image, in order to grasp in which part the residue remains, in some cases, it is not easy to grasp the position of the residue in the article only from the image in which the bone or the like is emphasized, and work efficiency of the removal work is significantly reduced.

The present invention is made in order to solve the problems described above in the related art, and an object of the present invention is to provide an X-ray inspection apparatus, an article inspection system, and an X-ray image forming apparatus s with which an operator easily and accurately grasps a situation of an inspection object related to an inspection or work while improving inspection performance such as foreign matter detection.

### Means for Solving the Problem

In order to achieve the object described above, according to a first aspect of the present invention, there is provided an X-ray inspection apparatus including: an inspection unit that detects X-rays transmitted through an inspection object in a plurality of energy regions, and inspects the inspection object by using a determination image generated by executing a predetermined image process on at least two pieces of X-ray transmission image data corresponding to at least two energy regions; display means for displaying an inspection result of the inspection unit; display image generation means for generating a display image by executing a display image process different from the image process for generating the determination image, on the X-ray transmission image data; and display control means for causing the display means to display the inspection result and the display image.

With this configuration, in the X-ray inspection apparatus according to the first aspect of the present invention, the display image is generated by the display image generation means such that an image brightness of the inspection object in the display image is different from an image brightness of the inspection object in the determination image, and is displayed on the display means together with the inspection result in a predetermined display mode. Therefore, an operator can easily and accurately grasp a situation of the inspection object corresponding to the inspection result of the inspection object and a situation of a particularly important inspection part or a target part for which an additional inspection or work may be required depending on the inspection result, from the display image suitable for visual observation at a glance, while ensuring required inspection performance by the determination image.

According to a second aspect of the present invention, in the X-ray inspection apparatus according to the first aspect, the determination image is a subtraction image obtained by performing a subtraction process on the transmission image data of the X-rays in the plurality of energy regions, which are transmitted through the inspection object, and the display image is an image in which an image brightness of the inspection object in the image has a higher contrast than an image brightness of the inspection object in the determination image.

In this manner, for the determination image which is a subtraction image, by adjusting the X-rays in the plurality of energy regions, a foreign matter, an unnecessary residue, a fault part, or the like, which have a different X-ray transmittance from the inspection object, can be reflected with a high contrast with respect to the inspection object, and for the display image of the inspection object which is generated separately from the determination image, the image of the article itself is a high contrast image with respect to the inspection object in the determination image, so that the situation of the particularly important inspection part or the target part for which the additional inspection or work may be required depending on the inspection result, can be easily and accurately grasped from the display image. The contrast referred to herein is a difference between a light level and dark level or a difference in brightness, and it is also conceivable to use a display mode in which the display image and the determination image can be compared and referred to.

According to a third aspect of the present invention, the X-ray inspection apparatus according to the first aspect, further includes: operation input means for inputting request information according to an operation input of a user, in which the display image generation means generates the display image as a plurality of different images in which the same target object is reflected, by executing a plurality of types of image processes set in advance on X-ray transmission image data of a specific energy region among the plurality of energy regions, based on the request information from the operation input means.

In this case, since the display image is generated as a plurality of different images in which the same inspection object is reflected, the operator can select the display image capable of easily and accurately grasping the situation of the inspection object and the situation of the particularly important inspection part or the target part for which the additional inspection or work may be required depending on the inspection result, by any one or a plurality of images among the plurality of different display images.

According to a fourth aspect of the present invention, in the X-ray inspection apparatus according to the third aspect, the display image generation means executes a plurality of types of image processes stored in advance to generate a total X-ray image corresponding to the X-ray transmission image data including the plurality of energy regions, and performs a subtraction process on the X-ray transmission image data of the plurality of energy regions under a plurality of different image processing conditions to generate a plurality of different types of subtraction images, and the operation input means performs an operation input of requesting a display output of any one image or a plurality of images among the total X-ray image and the plurality of different types of subtraction images and an operation input of requesting a change setting of the display output.

In this configuration, by generating the plurality of different types of subtraction images such that a thickness or a shape of the entire inspection object or a portion of interest is easily reflected in the total image and a defective part such as a foreign matter, an unnecessary residue, or a fault part in the inspection object is relatively easily reflected in the subtraction image, the subtraction image with which a specific portion of the inspection object including the defective part is easily grasped can be easily specified.

According to a fifth aspect of the present invention, in the X-ray inspection apparatus according to the fourth aspect, the plurality of different types of subtraction images are subtraction images in which article-affected brightness variation of the inspection object in the image are different from each other according to the plurality of different image processing conditions.

In this case, since the article-affected brightness variation of the inspection object in the plurality of different types of subtraction images are different from each other, the subtraction image with which a specific portion of interest of the inspection object including the defective part (for example, the thick portion or the thin portion) is easily grasped is further facilitated to be specified.

According to a sixth aspect of the present invention, there is provided an article inspection system including: the X-ray inspection apparatus according to the first aspect; a transport device that transports an article on a predetermined transport path; and a post-process booth disposed on a downstream side of the transport path, in which an inspection unit of the X-ray inspection apparatus has an X-ray detector that detects X-rays transmitted through the article on the transport path, and outputs a detection signal, and display image generation means of the X-ray inspection apparatus outputs a display image to post-process display means installed in the post-process booth.

With this configuration, in the article inspection system of the present invention, the display image is output to the post-process display means of the post-process booth, so that a target part for an additional inspection or work in the post-process booth can be easily and accurately grasped based on the display image at a glance, and processing efficiency in the post-process booth can be improved.

According to a seventh aspect of the present invention, there is provided an X-ray image forming apparatus including: a transmission image data generation unit to which a detection signal of X-rays transmitted through an article is input and which generates X-ray transmission image data in a plurality of different energy regions; an image processing unit that executes a predetermined image process on the X-ray transmission image data in the plurality of energy regions to generate at least a subtraction image of the X-ray transmission image data; and an image output unit that causes display means to output the image generated by the image processing unit, in which the image processing unit includes display image generation means for generating a total X-ray image corresponding to the X-ray transmission image data including the plurality of energy regions, and executing the predetermined image process on the X-ray transmission image data in the plurality of energy regions under a plurality of subtraction image processing conditions to generate a plurality of different types of subtraction images as the subtraction image, and the image output unit includes selection operation means for selecting and setting at least one image of the total X-ray image and the plurality of different types of subtraction images generated by the display image generation means in a switchable manner as an image to be displayed and output.

With this configuration, in the X-ray image forming apparatus of the present invention, the display image generation means of the image processing unit generates the total X-ray image corresponding to the X-ray transmission image data including the plurality of energy regions, and executes the predetermined image process on the X-ray transmission image data of the plurality of energy regions under the plurality of different image processing conditions to generate the plurality of different types of subtraction images. By the selection operation means of the image output unit, at least one image of the total X-ray image and the plurality of different types of subtraction images is selected and set in a switchable manner as an image to be displayed and output. Therefore, an operator can easily and accurately grasp a situation of the inspection object corresponding to the inspection result of the inspection object and a situation of a particularly important inspection part or a target part for which an additional inspection or work may be required depending on the inspection result, from the display image suitable for visual observation, while ensuring required inspection performance by the determination image.

According to an eighth aspect of the present invention, there is provided an article processing system including: the X-ray image forming apparatus according to the seventh aspect; a transport device that transports an article on a predetermined transport path; and a post-process booth disposed on a downstream side of the transport path, in which a transmission image data generation unit of the X-ray image forming apparatus has an X-ray detector that detects X-rays transmitted through the article on the transport path, and outputs a detection signal, and the post-process booth has post-process display means for displaying and outputting at least one of a total X-ray image and a plurality of different types of subtraction images, which are generated by the image processing unit and selected and set by the selection operation means.

With this configuration, in the article processing system according to the present invention, at least one image of the total X-ray image and the plurality of different types of subtraction images, which are generated by the image processing unit and are selected and set by the selection operation means, is displayed and output by the post-process display means of the post-process booth. Therefore, a user who operates the selection operation means can easily and accurately grasp the target part for the additional inspection or the work in the post-process booth based on the display image suitable for visual observation at a glance, and the processing efficiency in the post-process booth is improved.

According to a ninth aspect of the present invention, in the article processing system according to the eighth aspect, the post-process display means is configured to include a plurality of displays spaced apart from each other at least in a transport direction of the article, and the post-process booth is provided with sorting means for sorting the article transported on the transport path in an additional process space corresponding to any one of the plurality of displays, in a transport order.

In the article processing system according to the ninth aspect, since the plurality of displays of the post-process display means are spaced apart from each other at least in an article transport direction by the transport path, the article transported to a downstream side of the transport path can be sorted in the additional process space corresponding to any one of the plurality of displays by the sorting means, in the transport order. The plurality of displays may be alternately arranged on both sides in a transport path width direction while being spaced apart from each other in the article transport direction.

### [Advantage of the Invention]

According to the present invention, it is possible to provide an X-ray inspection apparatus, an article inspection system, and an X-ray image forming apparatus with which an operator easily and accurately grasps a situation of an inspection object related to an inspection or work while improving inspection performance such as foreign matter detection.

### BRIEF DESCRIPTION OF THE DRAWINGS

FIG. 1 is a schematic configuration diagram illustrating an article inspection system including an X-ray inspection apparatus as an X-ray image forming apparatus according to a first embodiment of the present invention.

FIG. 2 is an explanatory diagram of a sensor configuration of an X-ray detector and a circuit configuration of transmission image data generation means in the article inspection system according to the first embodiment of the present invention.

FIG. 3 is a graph for describing a wave peak value division, in which a signal level of a pulse-shaped X-ray detection signal output from a plurality of sensors of the X-ray detector in the article inspection system according to the first embodiment of the present invention is displayed in a plurality of region divisions obtained by dividing a region of X-ray energy, in which a vertical axis represents a pulse signal level and a horizontal axis represents a scan time.

FIG. 4 is an explanatory diagram illustrating a state in which a display image selection function is selected from an inspection screen during inspection stop on a touch panel as an operation display unit in the article inspection system according to the first embodiment of the present invention, and a display image setting menu is expanded and displayed, in which a display image selection screen is displayable in the display image setting menu.

FIG. 5 is an explanatory diagram of a screen illustrating a state in which the display image selection screen having a plurality of display image preview image display regions is displayed on the touch panel as the operation display unit in the article inspection system according to the first embodiment of the present invention.

FIG. 6 is an explanatory diagram of an operation screen which displays a comparison of a plurality of predetermined display images that can be selected and set by scrolling (moving and displaying) left and right within a display screen setting frame, which is a preview image display region of the display image selection screen, on the touch panel as the operation display unit in the article inspection system according to the first embodiment of the present invention.

FIG. 7 is an explanatory diagram of a display image setting operation screen in which a display screen setting frame, which is a preview image display region of the display image selection screen, is displayed in a pop-up manner in a display image setting menu screen on the touch panel as the operation display unit in the article inspection system according to the first embodiment of the present invention.

FIG. 8 is a schematic configuration diagram of an article processing system including an X-ray inspection apparatus according to a second embodiment of the present invention.

### BEST MODE FOR CARRYING OUT THE INVENTION

Hereinafter, embodiments according to the present invention will be described with reference to the drawings.

### First Embodiment

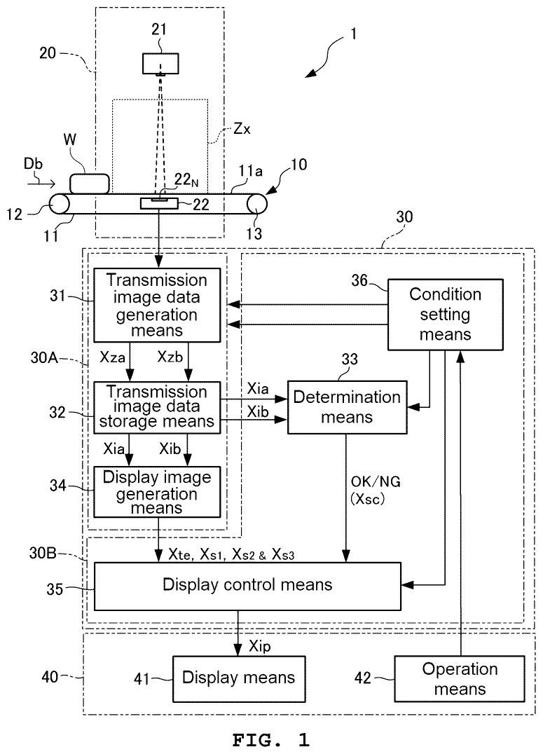

FIGS. 1 to 7 illustrate an article inspection system including an X-ray image forming apparatus according to a first embodiment of the present invention.

First, a configuration thereof will be described.

An X-ray inspection apparatus 1 illustrated in FIG. 1 includes an article transport unit 10, an X-ray inspection unit 20, an inspection processing unit 30, and an operation display unit 40, and constitutes a part of an article inspection system provided with a sorting device (not illustrated) or the like at a latter stage of the article transport unit 10.

The article transport unit 10 transports an inspection object W (article) in a direction of an arrow Db in FIG. 1 (a predetermined transport direction; hereinafter, also simply referred to as a Db direction), and, for example, a loop-shaped transport belt 11 is stretched between parallel rollers 12 and 13, and the inspection object W on a transport path 11a serving as an upper running section of the transport belt 11 is transported at a constant speed while passing through an inspection region Zx by the X-ray inspection unit 20. The article transport unit 10 is a belt conveyor which drives any of the rollers 12 and 13 by a motor and in which the transport path 11a is flat here, and may be a type in which the inspection object W is transported through a tubular transport path or a type in which the inspection object W passes through the inspection region Zx by own weight.

The X-ray inspection unit 20 includes an X-ray generator 21 and an X-ray detector 22 that are disposed with the transport path 11a of the article transport unit 10 therebetween. The X-ray generator 21 and the X-ray detector 22 are disposed to face each other while being spaced apart from each other up and down in a vertical direction, for example, here, and may be disposed to be spaced apart from each other in both the vertical direction and a horizontal direction.

The X-ray generator 21 emits X-rays toward the transport path 11a side of the inspection object W by the article transport unit 10, and in the present embodiment, the inspection object W is irradiated with the X-rays downward from a vertically upward side. Meanwhile, the irradiation direction of the X-rays from the X-ray generator 21 is not limited to the downward direction, and may be another direction.

An X-ray source of the X-ray generator 21 is, for example, an X-ray tube with a thermal cathode incorporated therein, and may be a grid-controlled thermal cathode X-ray tube that controls an X-ray amount (for example, reduces the X-ray amount with a negative grid voltage) by controlling a grid voltage applied to a control grid.

The X-ray generator 21 applies a direct-current negative potential to a cathode of an X-ray tube (not illustrated), for example, emits electrons from a filament that is lit at a high temperature, and focuses electrons emitted from the filament using a focusing electrode to which a direct-current negative potential is while applying a direct-current positive potential to a target to accelerate the electrons emitted from the filament at a high voltage and cause the electrons to collide with the target, thereby generating X-rays from the target.

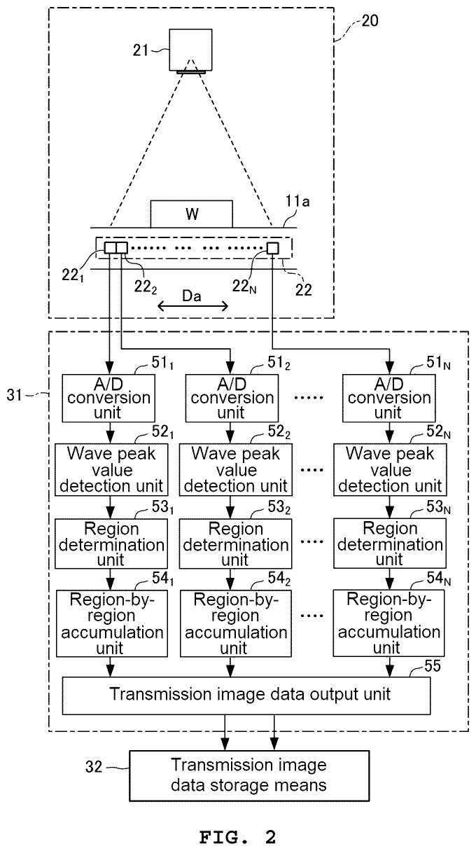

As illustrated in FIG. 2, the X-ray detector 22 includes a plurality of sensors 22₁ to 22_{N} that receive X-rays and convert the X-rays into electric signals, and the plurality of sensors 22₁ to 22_{N} output detection information of the X-rays as the electric signals. These plurality of sensors 22₁ to 22_{N} are arranged side by side in a row in a state in which there is almost no gap in an arrow Da direction (a width direction of the transport path; hereinafter, also simply referred to as a Da direction) orthogonal to the transport direction of the inspection object W at a position at which the X-rays emitted from the X-ray generator 21 are received after being transmitted through the inspection object W.

Specifically, the X-ray detector 22 is configured with one line sensor in which the plurality of sensors 22₁ to 22_{N} are integrally coupled, and is disposed on a lower side of the transport path 11a inside the loop-shaped transport belt 11 of the article transport unit 10. Here, for example, if each sensor width of the plurality of sensors 22₁ to 22_{N} in the Da direction is 1 mm, a gap between the sensors is sufficiently small with respect to a sensor width, and a width of the transport path 11a for transporting the inspection object W in the Da direction is 200 mm, it is sufficient to use a line sensor having approximately 200 sensors. The X-ray detector 22 can output detection information for X-rays of a plurality of different energy regions, respectively. Details of this configuration will be described below.

As illustrated in FIG. 1, the inspection processing unit 30 is configured with an image processing block 30A that generates X-ray transmission image data and a control block 30B that executes predetermined inspection control, display output control, and the like based on the X-ray transmission image data from the image processing block 30A. In addition, the image processing block 30A includes transmission image data generation means 31, transmission image data storage means 32, and display image generation means 34, and the control block 30B includes determination means 33, display control means 35, and condition setting means 36.

The inspection processing unit 30 is realized by a combination of hardware, such as a central processing unit (CPU) and a random access memory (RAM), and software, such as a program that exhibits various functions on the hardware without being illustrated in detail, and may include a field programmable gate array (FPGA), a digital signal processor (DSP), or the like, for example. The various functions referred to herein are functions of each means for generating the X-ray transmission image data, performing predetermined inspection control, display output control, and the like.

The transmission image data generation means 31 performs a predetermined signal process by dividing electric signals (detection information) in units of a scan time set in advance, which are respectively output from the plurality of sensors of the X-ray detector 22 while the inspection object W passes through between the X-ray generator 21 and the X-ray detector 22, detect information on a two-dimensional position defined in the Db direction, which is a transport direction of the inspection object W, and the Da direction in which the sensors 22₁ to 22_{N} are arranged, and an image tone value according to a signal processing result for each position, and generate transmission image data of the inspection object W.

In addition, in response to the X-ray detector 22 outputting the detection information of each of a plurality of different energy regions, the transmission image data generation means 31 generates the transmission image data of the inspection object W, corresponding to each of the plurality of energy regions.

Specifically, the X-ray detector 22 outputs detection information of X-rays in a certain energy region, for example, a first energy region, and the transmission image data generation means 31 generates first X-ray transmission image data (X_{za} in FIG. 1) based on the detection information of the X-rays in the first energy region. The first energy region referred to herein is, for example, an energy region in which energy of X-rays is 20 keV to 40 keV. In addition, the X-ray detector 22 outputs detection information of X-rays in an energy region different from the first energy region, for example, a second energy region, and the transmission image data generation means 31 generates second X-ray transmission image data (X_{zb} in FIG. 1) based on the detection information of the X-rays in the second energy region. The second energy region referred to herein is, for example, an energy region in which energy of X-rays is 50 keV to 70 keV.

That is, in the present embodiment, energy of X-rays corresponding to a detection signal level of the X-ray detector 22 has a magnitude relationship of the “first energy region”< “second energy region”. In the example described above, the description is made in a state in which the first energy region is set to 20 keV to 40 keV and the second energy region is set to 50 keV to 70 keV, and these two energy regions are spaced apart from each other, and the embodiment is not limited thereto. The relationship between these two energy regions may be any of separation, adjacency, and partial overlap, and it is sufficient that a central value of each energy region satisfies the magnitude relationship described above. In addition, the number of energy regions is not limited to two, and may be three or more energy regions having different central values.

The transmission image data storage means 32 has an image memory function of sequentially taking transmission image data generated by the transmission image data generation means 31 in correspondence with each of the plurality of energy regions, that is, the transmission image data X_{za} and X_{zb} of the inspection object W generated based on two-dimensional position information of the inspection object W and a signal processing result for each position by executing a predetermined signal process for each scan time, as line image data for each scan time over a predetermined inspection time. In addition, each time a predetermined inspection time elapses, the transmission image data storage means 32 stores transmission image data Xᵢₐ and X_{ib} in which the entire inspection object W is reflected as transmission images of X-rays of the first and second energy regions (the plurality of different energy regions) such that the transmission image data Xᵢₐ and X_{ib} can be respectively read out. The predetermined inspection time is, for example, an X-ray inspection time of each inspection object W, which is set in accordance with a length and a transport speed of each inspection object W in the transport direction based on a timing of the transport of the inspection object W to the article transport unit 10, and is set as a time sufficient for each inspection object W to completely pass over the X-ray detector 22.

The determination means 33 executes, according to a determination processing condition set in advance and stored, and a condition additionally set by the condition setting means 36, an image process for determination of a predetermined image processing algorithm on each of at least two pieces of the transmission image data Xᵢₐ and X_{ib} corresponding to the same inspection object W among the plurality of pieces of the transmission image data of the X-rays of the plurality of energy regions stored in the transmission image data storage means 32, and execute a subtraction process known as an energy subtraction process between the processed transmission image data Xᵢₐ and X_{ib} to determine the presence or absence of a defective portion such as a foreign matter or a bone in the inspection object W based on transmission image data (hereinafter, also simply referred to as a subtraction image) X_{sc} obtained as a result of the subtraction process. The predetermined image processing algorithm here is a combination of, for example, a plurality of image processing filters and an image process for feature extraction.

In a case where the subtraction process as described above is performed, for example, by setting each energy region such that, among the X-rays of the plurality of energy regions, X-rays in any low-energy region are less likely to be transmitted through a defective portion such as a foreign matter or a bone, and X-rays in a high-energy region are relatively likely to be transmitted through the defective portion such as the foreign matter or the bone, transmission image data in which the defective portion such as the foreign matter or the bone is emphasized is obtained in the subtraction image as compared with an article-affected image that reflects the inspection object W itself, so that it is possible to increase determination accuracy of the determination means 33 that determines whether or not the defective portion in which the foreign matter is contained or the bone is left behind occurs in the inspection object W.

The determination result (a signal indicating the presence or absence of the defective portion described above) of the determination means 33 is used as a sorting command signal for controlling a latter-stage sorting device (not illustrated), and when the inspection object W determined to have the defective portion reaches the sorting device, the defective inspection object W is excluded to an outside from a transport path of a non-defective product extending on a downstream side of the sorting device in response to the sorting command signal.

The display image generation means 34 executes a predetermined display image process on the transmission image data Xᵢₐ and X_{ib} of the X-rays of the first and second energy regions stored in the transmission image data storage means 32 to generate a display image different from the determination image X_{sc} in which the subtraction process described above is performed on at least an image brightness of the inspection object W. Here, the predetermined display image process is executing of an image process of applying a predetermined image processing algorithm or the like to each of the transmission image data Xᵢₐ and X_{ib} of each energy region read out from the transmission image data storage means 32, and the predetermined image processing algorithm is a combination of, for example, a plurality of image processing filters and an image process for feature extraction.

Specifically, for the determination image obtained in the determination means 33, as described above, the subtraction image data X_{sc} obtained by performing the subtraction process on the X-ray transmission image data Xᵢₐ and X_{ib} of the plurality of energy regions is transmission image data in which the defective portion such as the foreign matter or the bone is emphasized, as compared with an X-ray image in which the inspection object W itself is an imaging target. Meanwhile, the display image generation means 34 generates image data of a display image Xᵢₚ suitable for visual observation in which an image brightness of the inspection object W has a higher contrast than an image brightness of the inspection object W in the determination image X_{sc} as a plurality of types of candidate images different from each other. The contrast referred to herein is a difference between a light level and dark level or a difference in brightness.

For example, the display image generation means 34 generates a total X-ray image Xₜₑ (transmission image data of X-rays in a total energy region including the X-rays in the plurality of energy regions) obtained by adding up tone values of the X-ray transmission image data Xᵢₐ and X_{ib} in the plurality of energy regions as one candidate of the display image Xᵢₚ. The total X-ray image Xₜₑ is obtained by adding the tone values of respective pixels of the high-energy image and the low-energy image, and may be used as an average value instead of adding the tone values of the respective pixels.

Further, the display image generation means 34 generates a plurality of different types of, visually distinctive, subtraction images Xₛ₁, Xₛ₂, and Xₛ₃ in which an image brightness of the inspection object W has a higher contrast than the determination image X_{sc} by executing a plurality of types of subtraction processes in which each processing condition is different for the predetermined determination image process (filter process, feature extraction process, subtraction processes, or the like) of the determination means 33, and the processing conditions of the subtraction process in the display image generation means 34 are further different from each other. The subtraction images Xₛ₁, Xₛ₂, and Xₛ₃ are displayed as other plurality of candidate images of the display image Xᵢₚ than the total X-ray image Xₜₑ. The subtraction image referred to here is an energy subtraction image using a high-energy image and a low-energy image, and an image in which a low brightness portion or a high brightness portion is emphasized is used for at least one of the high-energy image or the low-energy image. When the plurality of different types of subtraction images Xₛ₁, Xₛ₂, and Xₛ₃ are displayed as the candidate images of the display image Xᵢₚ, it is also possible to consider displaying the determination image X_{sc} in a display mode in which the determination image X_{sc} can be compared and referred to.

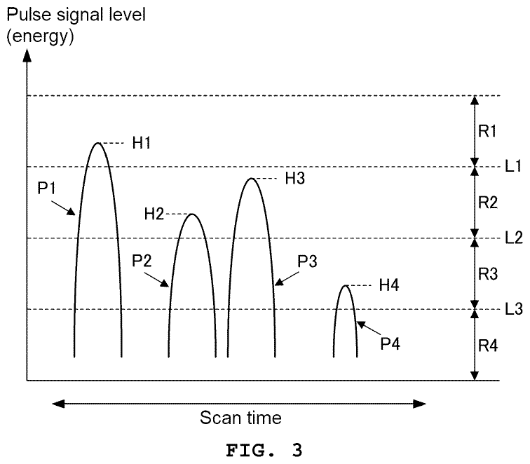

The plurality of types of subtraction processes are processes of, for example, selecting X-ray detection signals in any two regions among a plurality of energy regions R₁, R₂, R₃, and R₄ illustrated in FIG. 3, and then executing the predetermined display image process described above on each of the X-ray detection signals and performing the subtraction process on X-ray transmission image data of the two regions. In this case, region boundary values L₁, L₂, and L₃ of pulse signal levels of the X-ray detector 22 that divides the plurality of energy regions R₁, R₂, R₃, and R₄ can be set such that the second energy region, which is on a high-energy side than the first energy region described above, includes a part of the energy regions R₁ and R₂ on a high-energy side and the first energy region includes a part of the energy regions R₃ and R₄ on a low-energy side among the plurality of energy regions R₁, R₂, R₃, and R₄ in FIG. 3. A plurality of pulse-shaped X-ray detection signals P1, P2, P3, and P4 during a scan time illustrated in FIG. 3 will be described below.

The operation display unit 40 is, for example, a touch panel type display device configured with a liquid crystal display (LCD) or the like, and has a function of display means 41 and a function of operation means 42 (operation input means).

The function of the display means 41 is a function of displaying various types of information required for the X-ray inspection, such as an operation state or setting information of the X-ray inspection apparatus 1, on a display screen. In addition, the function of the operation means 42 is, for example, a function of performing various touch panel operations, such as a selection operation of a display screen, a mode switching operation of whether an operation mode is an inspection mode, a setting mode, or another mode, and a function of inputting request information according to an operation input of a user in an operation function of performing an operation of setting, inputting, or the like various parameters under the setting mode.

The operation display unit 40 is not limited to a touch panel integrated with the X-ray inspection apparatus 1, and may be provided in a form of a portable tablet type information terminal or the like, or may be additionally installed in a form of a display, an operation panel, or the like different from the touch panel integrated with the X-ray inspection apparatus 1.

The display control means 35 executes a predetermined display control process by taking an OK/NG signal (further, the determination image X_{sc} according to a display request) which is a determination result from the determination means 33, candidate image data of the display image Xᵢₚ, which is generation image data of the display image generation means 34, for example, the total X-ray image Xₜₑ and the plurality of different types of subtraction images Xₛ₁, Xₛ₂, and Xₛ₃, a request operation input from the operation means 42, for example, a display control condition set by the condition setting means 36 according to a type selection operation of the inspection object W, and the like. The display control means 35 causes the display means 41 to display a result of the X-ray inspection and the display image Xᵢₚ of the inspection object W, which is the inspection target, in a display mode set according to the type and other inspection conditions by the condition setting means 36.

For example, when the type of the inspection object W is set, the display control means 35 generates the total X-ray image Xₜₑ and the plurality of different types of subtraction images Xₛ₁, Xₛ₂, and Xₛ₃ for a sample of the inspection object W for the type setting, as candidates for the display image Xᵢₚ displayed on the display means 41. The display control means 35 can generate, and display and output the candidate image data Xₜₑ, Xₛ₁, Xₛ₂, and Xₛ₃ of the plurality of display images Xᵢₚ as the candidates for the display image Xᵢₚ appropriate for observation of each user who uses the operation display unit 40 in a scrollable, selectable, and operable manner by the display means 41 on a screen, in an inspection before state in which the type setting is completed, in an inspection stop state in which a switching request operation input of the display image Xᵢₚ from the operation means 42 is performed, or in another non-inspection state. In a case where the display devices are installed at a plurality of locations as the display means 41, a selection setting of the display image Xᵢₚ may be enabled for each of the display devices.

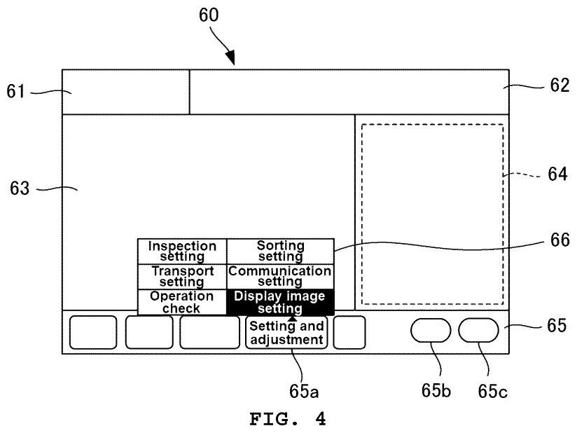

The display control means 35 also stores and holds a display control program and display screen information for displaying and expanding any of display screen groups stored in a stepwise-expandable manner from a main menu screen on the display means 41 in response to an operation input to the operation means 42, and displaying a first operation display screen 60 illustrated in FIG. 4, for example, on the display means 41 in response to the operation input to the operation display unit 40 when the X-ray inspection apparatus 1 operates in the inspection mode.

As illustrated in FIG. 4, the first operation display screen 60 includes an inspection state display region 61 for displaying what inspection state the X-ray inspection apparatus 1 is in, a common information display region 62 for displaying information common to the entire inspection regardless of the inspection condition such as the type, an image display region 63 for displaying the inspection object W as an inspection target, an inspection information display region 64 for displaying main inspection information corresponding to the currently set type, an operation button display region 65 for aligning and displaying operation unit images such as a plurality of operation buttons in a tabular form and functioning as a part of the operation display unit 40, and the like.

In the first operation display screen 60, when a touch operation is performed on a setting and adjustment button 65a in the operation button display region 65, the condition setting means 36 of the inspection processing unit 30 can shift the X-ray inspection apparatus 1 to the inspection stop state, and can expand and display a function selection and setting operation window 66 in which a function such as an inspection setting, a sorting setting, a transport setting, a communication setting, an operation check request, a display screen setting, or the like can be selected and set above the operation unit image of the setting and adjustment button 65a.

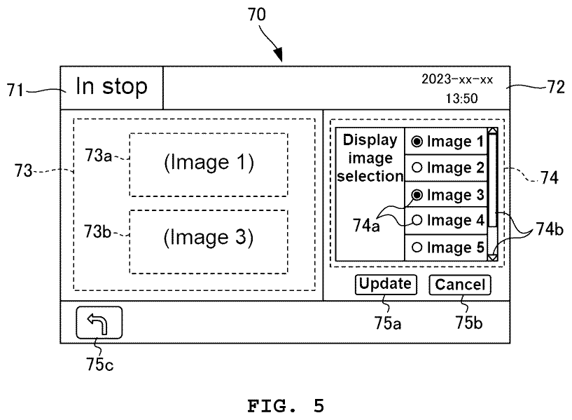

Further, when the display screen setting in the function selection and setting operation window 66 is selected, the display control means 35 can shift the X-ray inspection apparatus 1 from the inspection stop state to the setting mode, and can cause the display means 41 to display and output a second operation display screen 70 as illustrated in FIG. 5.

As illustrated in FIG. 5, the second operation display screen 70 includes an inspection state display region 71 for displaying that a state is in the inspection stop, a common information display region 72 for displaying information common to the entire inspection regardless of the inspection condition, a preview image display region 73 for displaying a plurality of candidate images 73a and 73b for specifying a type of the display image Xᵢₚ of the inspection object W as an inspection target, a selection input display region 74 for a display image type, which has a radio button 74a and a scroll button 74b for a selection operation, and a selection setting operation screen of the display image Xᵢₚ including an update button 75a for a selected image type by a selection input in the selection input display region 74, a cancel button 75b for the selected image type by the selection input in the selection input display region 74, and a return operation button 75c for returning, after an operation is performed, to a state before the operation.

In this case, the second operation display screen 70 is displayed by the display image selection function of the function selection and setting operation window 66, and if the supply of the inspection object W is stopped once to be shift to the inspection stop state or the like, the second operation display screen 70 can be displayed by the display means 41 by selecting a display image setting menu in the function selection and setting operation window 66.

In addition, if the display image setting menu is selected, a plurality of selection candidates of the display image Xᵢₚ that can be displayed on the second operation display screen 70 are read out from a memory of the condition setting means 36, the number of display images is narrowed down according to a selection input in the selection input display region 74, and the display images are displayed as preview images (images 1 and 3 in FIG. 5). In addition, by shifting to a management mode in which an access is restricted by an input of a passcode from the operation means 42, the update button 75a or the cancel button 75b in the second operation display screen 70 can be operated, and the display candidate can also be changed or added. Further, if an image to be displayed is selected from the selection candidates, a candidate image of the display image Xᵢₚ on which the corresponding emphasis process or the like is to be performed is preview-displayed based on the latest transmission image data which is stored. The setting item can be switched on and off by an operation on the touch panel, and the preview display can be switched by pressing the update button 75a. In addition, until the return operation button 75c is pressed, the selection can be changed, and when the setting in the non-inspection state is ended and the inspection in the inspection mode is started, the X-ray inspection is restarted for the inspection object W that is sequentially transported, and the inspection result and the display image Xᵢₚ of the newly set image type are displayed on the display means 41.

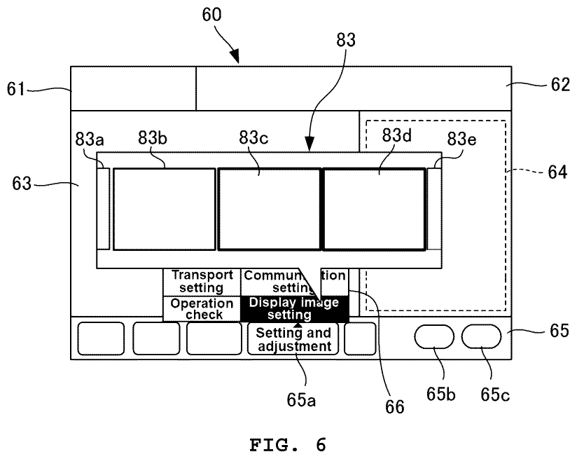

Alternatively, as illustrated in FIG. 6, when the display screen setting in the function selection and setting operation window 66 is selected, the display control means 35 may pop-up display a display screen selection setting window 83 on the touch panel constituting the display means 41 of the operation display unit 40, instead of the preview image display region 73 of the display image selection screen 70. A plurality of candidate images 83a, 83b, 83c, and the like for specifying the type of the display image Xᵢₚ of the inspection object W as an inspection target may be aligned and displayed in the display screen selection setting window 83 in a predetermined direction, for example, in a scrollable (move and display), selectable, and settable manner in a left and right direction, and an operation of selecting and setting a specific type of display image may be performed. In this case, the plurality of candidate images 83a, 83b, 83c, and the like can be preview-displayed in a scrollable manner as thumbnail images without being displayed in the image display region for preview. In addition, if some of the plurality of candidate images 83a to 83f that are preview-displayed, for example, the candidate images 83c and 83d of the specific image type in FIG. 6 are appropriately scrolled and selected by the touch panel operation in a state in which the display screen selection setting window 83 is displayed in a pop-up manner, a selection state in which a thick frame for the both candidate images 83c and 83d is more emphasized than the other candidate images is made before a determination. If the display image setting button is pressed again in the selection state before the determination, the selection setting is determined and is applied in the condition setting means 36.

Of course, in a case where an operation of selecting the function of the display screen setting is performed in a state in which the function selection and setting operation window 66 is displayed on the first operation display screen 60, a display control condition of whether to display the display image selection screen 70 or to pop-up display the display screen selection setting window 83 can be alternatively selected and determined by the condition setting means 36, and can be switched as necessary. Alternatively, it is also conceivable to switch whether to shift the function selection and setting operation window 66 to the display output of the display image selection screen 70 or to the pop-up display of the display screen selection setting window 83, by performing a touch operation input with different operation conditions.

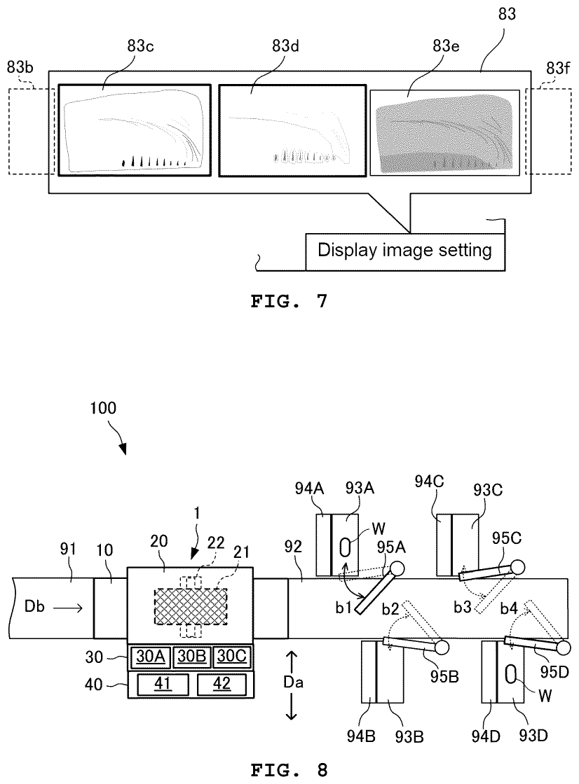

Also in a case where the preview image display region 73 of the display image selection screen 70 or any of the display screen selection setting windows 83 that are pop-up displayed in the first operation display screen 60 is displayed, the display image generation means 34 executes a plurality of types of image processes (display image process) that are set in advance, on X-ray transmission image data in a specific energy region among the plurality of energy regions from request information from the operation means 42 to generate a plurality of candidate images (including the candidate images 83b, 83f, and the like that are outside the display screen selection setting window 83 in FIG. 7) partially illustrated as the candidate images 83c to 83e in a specific scroll region in the display screen selection setting window 83 in FIG. 7, for example, by using the display image Xᵢₚ as a plurality of different candidate images in which the same target object is reflected.

For example, the display image generation means 34 generates the total X-ray image Xₜₑ corresponding to the X-ray transmission image data including the plurality of energy regions as some of the plurality of candidate images 83a, 83b, 83c, 83d, 83e, and 83f, by executing a plurality of types of image processes stored in advance in the memory as a predetermined image process for generating a display image, and generates the plurality of different types of subtraction images Xₛ₁, Xₛ₂, and Xₛ₃ obtained by performing the subtraction process on the X-ray transmission image data of the plurality of energy regions under a plurality of different processing conditions. As described above, the plurality of types of subtraction processes are processes of selecting X-ray detection signals in any two regions among the plurality of energy regions R₁, R₂, R₃, R₄, and the like and executing the image processing filter or the feature extraction process on each of the X-ray detection signals, and then performing the subtraction process on X-ray transmission image data of the two regions of each set, and may include the determination image X_{sc}.

Examples of the image type of the display image Xᵢₚ include a subtraction image in which a light portion (for example, a thick portion of the inspection object W) of the X-ray transmission image on a high-energy region side is emphasized, in addition to the total X-ray image Xₜₑ described above and a simple subtraction image corresponding to the determination image X_{sc}, a subtraction image in which a dark portion (for example, a portion of a foreign matter or an unnecessary residue) of the X-ray transmission image on a low-energy region side is emphasized, a subtraction image in which a dark portion (for example, the portion of the foreign matter or the unnecessary residue) of the X-ray transmission image on the high-energy region side is emphasized, a subtraction image in which a light portion (for example, a thin portion of the inspection object W) of the X-ray transmission image on the low-energy region side is emphasized, and the like. Meanwhile, the candidates for the display image are not necessarily limited to these, and a selection list of the display image Xᵢₚ can be displayed to be set and changed or scrollable such that the X-ray transmission image on the high-energy region side, the X-ray transmission image on the low-energy region side, and the X-ray transmission image before the subtraction process in which the emphasis process is performed can be selected.

Also in the preview image display region 73 of the display image selection screen 70 and also in the display screen selection setting window 83 that is displayed in a pop-up manner in the first operation display screen 60, the number of display modes that can be switched is, for example, three or more, and it is needless to say that the number of display modes that can be switched may be two, or four or more. In addition, if a grayscale display can be performed, the grayscale display may be performed, but only a screen frame and an option that is a candidate for the display image Xᵢₚ may be displayed. Only the selected image may be preview-displayed as a display image selected by the display frame of the thick frame.

In the display screen selection setting window 83 illustrated in FIG. 7, the dotted line indicates that the candidate images 83b and 83f are outside a selectable region, and the candidate image 83b or 83f can be made selectable by moving the candidate image 83b or 83f into the selectable region by an operation on the touch panel. In addition, if a display image setting button is pressed again in the state in which the display image is displayed in a pop-up manner, the setting is applied. This corresponds to the return operation button 75c on the display image selection screen 70, and a difference from the display in the preview image display region 73 in the display image selection screen 70 is that a thumbnail image is displayed as a preview display even without the preview aforementioned.

In this manner, the operation means 42 (operation input means) is capable of an operation input for requesting a display output in a state in which any one image or a plurality of images of the total X-ray image Xₜₑ and the plurality of different types of subtraction images Xₛ₁, Xₛ₂, Xₛ₃, and the like are selected and set, and an operation input for requesting a change setting of such display output, and in FIG. 7, which is a selection operation, is performed on the candidate images 83c and 83d, and the emphasis display of the thick frame is performed on the both candidate images 83c and 83d as compared with the other candidate images, the selected and set image type is displayed when a touch operation.

As illustrated in FIG. 7, the plurality of candidate images 83a to 83f corresponding to the plurality of different types of subtraction images Xₛ₁, Xₛ₂, Xₛ₃, and the like, for example, the candidate images 83c, 83d, and 83e, are subtraction images in which article-affected brightness variation of the inspection object W in the respective images are different from each other according to the plurality of different image processing conditions, and for the candidate image 83d having a low article-affected brightness variation of the inspection object W (cut fish in the illustrated example), a portion having a brightness equal to or less than a predetermined tone value is not displayed, and an image region of interest of the inspection object W is displayed as an image focused on a portion having a thickness equal to or more than a certain thickness. On the contrary, the candidate image 83e of the inspection object W having a high article-affected brightness variation is an image corresponding to the total X-ray image Xₜₑ corresponding to the X-ray transmission image data including the plurality of energy regions.

Next, a detailed configuration of the X-ray inspection unit 20 illustrated in FIG. 2 and the plurality of pulse-shaped X-ray detection signals P1, P2, P3, and P4 during the scan time illustrated in FIG. 3 will be described.

FIG. 3 illustrates an example of, in a case where the X-ray inspection unit 20 uses, for example, a photon detection type sensor as a plurality of sensors of the X-ray detector 22, a generated image during a predetermined scan time in the transmission image data generation means 31 corresponding to the photon detection type sensor.

As illustrated in FIG. 2, the transmission image data generation means 31 includes A/D conversion units 51₁ to 51_{N} to which an X-ray detection signal in each of detection width regions in the Da direction is input from the plurality of sensors 22₁ to 22_{N} of the X-ray detector 22, wave peak value detection units 52₁ to 52_{N} that detect a wave peak value (details will be described below) of the X-ray detection signal based on the output signals of the A/D conversion units 51₁ to 51_{N} which are output at a predetermined calculation period, region determination units 53₁ to 53_{N} that determine the X-ray energy region each detected based on the wave peak value detected by the wave peak value detection units 52₁ to 52_{N}, region-by-region accumulation units 54₁ to 54_{N} that execute a process of accumulating signal level values during a scan time while taking a determination result of the region determination units 53₁ to 53_{N} at the predetermined calculation period as the signal level values of the X-ray detection signals, and a transmission image data output unit 55 that generates and outputs transmission image data of a line image corresponding to the scan time based on a position of a detection width region of the plurality of sensors 22₁ to 22_{N} in the Da direction and an elapsed time during the scan time.

The article transport unit 10 and the X-ray inspection unit 20 in FIG. 2 are diagrams of the article transport unit 10 and the X-ray inspection unit 20 illustrated in FIG. 1 as viewed from the Db direction in FIG. 1, which is the article transport direction.

When describing the X-ray detector 22 in more detail, the X-ray detector 22 is configured with a line sensor in which N pieces of photon detection type sensors that output a pulse signal having a wave peak value corresponding to energy of a photon as detection information each time the photon of the X-ray transmitted through the inspection object W is input to the photon detection type sensor are arranged in a transport width direction as the plurality of sensors 22₁ to 22_{N}. Therefore, the transmission image data generated by the transmission image data generation means 31 represents a brightness of a transmission image corresponding to the number of pulses output by each of the sensors 22₁ to 22_{N} per unit time.

The sensors 22₁ to 22_{N} output one pulse signal having a wave peak value corresponding to energy of a photon for one input of the photon. Since the X-ray generator 21 emits X-rays in which photons of X-rays having different energies (wavelengths) are mixed, the pulse signals output from each of the sensors 22₁ to 22_{N} have variations in wave peak values.

If it is determined which of a plurality of different signal level sections constituting the entire output range of the wave peak value in advance, for example, the plurality of energy regions R₁, R₂, R₃, and R₄ illustrated in FIG. 3, the wave peak value of the pulse signal output from each sensor 22₁ to 22_{N} within a scan time enters, and the number of pulse signal inputs within the scan time is accumulated for each detection width region of each sensor, it is possible to generate a plurality of pieces of transmission image data having different ranges of the X-ray transmission energy, for example, the X-ray transmission image data X_{za} and X_{zb} of the first and second energy regions, for a passing portion of the inspection object W corresponding to the scan time.

In addition, in order to generate the plurality of pieces of transmission image data having different ranges of the X-ray transmission energy, the transmission image data generation means 31 converts the output signal of each of the sensors 22₁ to 22_{N} associated with the positions in the Da direction which is the transport width direction into a digital data string by the A/D conversion units 51₁ to 51_{N}, and inputs the digital data string to the wave peak value detection units 52₁ to 52_{N}.

Each of the wave peak value detection units 52₁ to 52_{N} is for detecting a wave peak value of a pulse signal from the input data string, and for example, performs a differentiation process on the input data string, detects a zero-cross timing at which a differentiation value (a slope of the signal) is switched from a positive value equal to or more than a predetermined value to a negative value equal to or less than the predetermined value, detects a data value at the zero-cross timing as the wave peak value of the pulse signal, and outputs the data value to the region determination units 53₁ to 53_{N}, respectively.

The region determination units 53₁ to 53_{N} compare the region boundary values L₁ to L_{M-1} in which an output range of a wave peak value is divided into M (a plurality of) regions R₁ to R_{M} with the wave peak value detected by the wave peak value detection units 52₁ to 52_{N}, determine in which region the wave peak value enters, and output a region identification signal representing the region in which the wave peak value enters to the region-by-region accumulation units 54₁ to 54_{N}.

Each of the region-by-region accumulation units 54₁ to 54_{N} receives the region identification signal output from each of the region determination units 53₁ to 53_{N} within the scan time, accumulates the number of inputs of the region identification signals indicating the same region, and sequentially outputs the cumulative number for each region within the scan time. The cumulative number of the region identification signals is the cumulative number of pulse signals among pulse signals output from one sensor within the scan time, having the same region in which the wave peak value enters.

The transmission image data output unit 55 sets the cumulative number of region identification signals output from the respective region-by-region accumulation units 54₁ to 54_{N} for each scan time to data arranged in parallel and in time series, and outputs the data as transmission image data for the inspection object W in each region.

The way to divide the region of the wave peak value described above is not unique, and as one example, the region may be divided evenly into a plurality of regions between a wave peak value of a pulse signal output by a sensor with respect to the maximum value of the energy of the photon of the X-rays emitted from the X-ray generator 21 (a theoretical value depending on an acceleration voltage of an electron in a case of an X-ray tube) and a predetermined reference value (for example, 0). In addition, the number of regions is also any number of two or more, and transmission image data may be generated in a large number of regions first, and transmission image data appropriate for each of the detection of the foreign matter or the mass measurement may be selected and used from the transmission image data.

For example, transmission image data may be generated in each region with an initial number of regions set to 10, and a first region counted from a region having the highest energy may be assigned to the region R₁, a third region may be selectively assigned to the region R₂ described above, and the like, from the initial region to the final region, and the transmission image data of the assigned region may be used. In addition, transmission image data of a plurality of regions in an initial state may be combined to obtain transmission image data of one region in a final state, and the combined transmission image data may be used. Specifically, transmission image data of the first and second regions counted from a region having the highest energy may be combined to obtain transmission image data of the region R₁ described above, and transmission image data of the third and fourth regions may be combined to obtain transmission image data of the region R₂ described above.

In the specific example illustrated here, the transmission image data is generated only for the number of initial regions, and the region is assigned and the transmission image data is combined according to the combination of the transmission image data optimum for the detection of the foreign matter or the like. Meanwhile, in a case where the combination of the transmission image data optimum for detection of a foreign matter or the like is known for the inspection object W, only the transmission image data for the assigned region need be generated, and instead of combining the plurality of transmission image data, the cumulative number of region identification signals of the plurality of regions may be added up to generate one transmission image data (total X-ray image). Thus, it is possible to save a storage region of the transmission image data storage means 32.

The plurality of pulse signal level regions R₁ to R_{M} can be a plurality of different X-ray energy regions. That is, by using the photon detection type sensor, the X-ray transmission image data in the plurality of different energy regions, including the first X-ray transmission image data X_{za} and the second X-ray transmission image data X_{zb} described above, are obtained. For example, the determination means 33 or the display image generation means 34 may perform the necessary image process by using the transmission image data in the energy region R₄ as the first X-ray transmission image data X_{za} and using the transmission image data in the region R₂ having X-ray energy higher than X-ray energy in the energy region R₄ as the second X-ray transmission image data X_{zb}.

In this manner, in the configuration using the photon detection type sensor and the transmission image data generation means 31 corresponding to the photon detection type sensor, it is possible to easily acquire X-ray transmission image data in a desired energy region, and it is possible to provide an X-ray inspection apparatus having an appropriate X-ray inspection function based on the X-ray transmission image data in the energy region appropriate for detecting a contained foreign matter, or an unnecessary residue such as a bone. In such an apparatus configuration, as described above, the display switching in the operation display unit 40 is executed after the X-ray inspection is temporarily stopped, and the operation display unit 40 displays an option of the display image that is selectable by the user. In addition, one or more of the options can be selected, and when being selected, the selected option is preview-displayed as a candidate image and/or a selected image. In this case, if a plurality of options are selected, the options are displayed side by side. In addition, it is also possible to read out the transmission image data, execute different image processes on one transmission image data, and generate a plurality of types of display images Xᵢₚ.

Next, operations will be described.

In the X-ray inspection apparatus 1 according to the present embodiment configured as described above, an X-ray inspection mode in which an X-ray inspection can be executed and other modes, for example, a setting mode in which various settings can be performed are switched by the condition setting means 36 according to an operation input of a mode selection to the operation means 42 of the operation display unit 40.

When the X-ray inspection is executed in the inspection mode of the X-ray inspection apparatus 1, the X-ray generator 21 of the X-ray inspection unit 20 emits X-rays to the inspection object W transported in the transport direction, that is, the Db direction by the article transport unit 10, the X-rays transmitted through the inspection object W are detected by the X-ray detector 22 and input to the transmission image data generation means 31, and transmission image data of the inspection object v corresponding to each of a plurality of energy regions, for example, the X-ray transmission image data X_{za} and X_{zb} of first and second energy regions are generated.

Further, the X-ray transmission image data X_{za} and X_{zb} of the inspection object W from the transmission image data generation means 31 are sequentially taken in by the transmission image data storage means 32 as line image data for each scan time over a predetermined inspection time, and can be respectively read as the transmission image data Xᵢₐ and X_{ib} in which the entire inspection object W is reflected.

The determination means 33 generates the determination image X_{sc} that is a subtraction image by an image process and a subtraction process of a predetermined image processing algorithm on the transmission image data read out from the transmission image data storage means 32, for example, the two pieces of transmission image data and X_{ib} corresponding to the same inspection object W, and determines the presence or absence of a defective portion such as a foreign matter or a bone in the inspection object W based on the determination image X_{sc}.

On the other hand, when the X-ray inspection in such an inspection mode is executed, the display control means 35 takes an OK/NG signal or the determination image X_{sc} which is a determination result from the determination means 33, the total X-ray image Xₜₑ and the different types of subtraction images Xₛ₁, Xₛ₂, Xₛ₃, and the like, which are generation image data of the display image generation means 34, a request operation input from the operation means 42, and the like, and displays a result of the X-ray inspection and the display image Xᵢₚ of the inspection target in a display mode set according to a type and other inspection conditions by the condition setting means 36, on the image display region 63 and the inspection information display region 64 of the first operation display screen 60.

An X-ray transmission image of the inspection object W as an inspection target generated by the same image process as any type of image selected and set in advance is displayed in the image display region 63 of the first operation display screen 60, when selecting the type of the display image, the function selection and setting operation window 66 is displayed in the first operation display screen 60, when selecting the display image setting function, the second operation display screen 70 is displayed, and a selection candidate for the display image Xᵢₚ, for example, the total X-ray image Xₜₑ and the plurality of different types of subtraction images Xₛ₁, Xₛ₂, Xₛ₃, and the like are displayed as selectable candidate images.

If an image type to be displayed is selected among a plurality of candidate images displayed in the preview image display region 73 of the second operation display screen 70, the display image Xᵢₚ in which the same image process as the selected type of image is executed is generated based on the latest transmission image data, and preview-displayed by, for example, emphasizing the display frame. Further, by shifting to a management mode in which an access is restricted by an input of a passcode from the operation means 42, the display candidate is changed or added.

Alternatively, according to a setting condition of the condition setting means 36, instead of the preview image display region 73 of the display image selection screen 70, the display screen selection setting window 83 is pop-up displayed, the plurality of candidate images 83a, 83b, 83c, and the like for specifying a type of the display image Xᵢₚ are aligned and displayed in a scrollable, and selectable, and settable manner, and an operation of selecting and setting a specific type of display image Xᵢₚ is performed.

Next, actions of the present embodiment will be described.

In the present embodiment, the display image generation means 34 generates the display image Xᵢₚ such that an image brightness of the inspection object W is different from an image brightness of the determination image X_{sc}, and the display image Xᵢₚ is displayed on the display means 41 together with a result of the inspection in a display mode set in advance. Therefore, required inspection performance is ensured by the determination image X_{sc}, and an operator who monitors an inspection situation by the display means 41 can easily and accurately grasp a situation of the inspection object W corresponding to an inspection result of the inspection object W and a situation of a particularly important inspection part or a target part for which an additional inspection or work may be required depending on the inspection result, from the display image Xᵢₚ displayed in the preview image display region 73 of the display image selection screen 70.

In addition, in the present embodiment, for the determination image X_{sc} that is a subtraction image, by adjusting the X-rays in the plurality of energy regions such that the inspection object W itself has a low contrast, a foreign matter, an unnecessary residue, a fault part, and the like, which have an X-ray transmittance different from an X-ray transmittance of the inspection object W, are reflected with a high contrast with respect to the inspection object W, and required inspection accuracy can be ensured. On the other hand, the candidate images Xₜₑ, Xₛ₁, Xₛ₂, Xₛ₃, and the like of the display image of the inspection object W generated separately from the determination image X_{sc} are images in which the image brightness of the inspection object W itself has a high contrast with respect to the image brightness of the inspection object W in the determination image X_{sc}, so that in a case where an additional inspection or work is to be performed on a downstream side or a latter stage side of the X-ray inspection apparatus 1, a target part of the additional inspection or the processing can be easily and accurately grasped from the display image Xᵢₚ.

In the present embodiment, since the display images Xᵢₚ is generated as the plurality of different candidate images Xₜₑ, X_{sc}, Xₛ₁, Xₛ₂, Xₛ₃, and the like in which the inspection object W of the same target is reflected, based on the X-ray transmission image data in the specific energy region among the plurality of energy regions, the operator can easily and accurately grasp a situation of the inspection object W and a situation of a particularly important inspection part or a target part for which an additional inspection or work may be required depending on the inspection result, by using any one or a plurality of images among the plurality of different display images Xᵢₚ.

In addition, in the present embodiment, a display output of any one image or a plurality of images among the total X-ray image Xₜₑ including the plurality of energy regions, and the plurality of different types of subtraction images Xₛ₁, Xₛ₂, Xₛ₃ can be easily changed and set to a display output mode to be requested according to a request operation input from the operation means 42. In addition, since the entire thickness or shape of the inspection object W is easily reflected in the total X-ray image Xₜₑ, and the plurality of different types of subtraction images Xₛ₁, Xₛ₂, Xₛ₃, and the like are displayed, a defective part such as a foreign matter, an unnecessary residue, or a fault part of the inspection object W is relatively easily reflected, and a subtraction image in which a specific portion of the inspection object W including the defective part is easily grasped can be selected.

In addition, in the present embodiment, since the plurality of different types of subtraction images Xₛ₁, Xₛ₂, and Xₛ₃ are subtraction images in which the article-affected brightness variation of the inspection object W are different from each other, the subtraction image in which the specific portion of the inspection object W including the defective part is easily grasped is further facilitated to be specified.

In this manner, according to the present embodiment, the X-ray image forming apparatus is provided in which the total X-ray image corresponding to the transmission image data Xᵢₐ and X_{ib} of the X-rays including the plurality of energy regions is generated by the transmission image data generation means 31 and the transmission image data storage means 32 of the image processing block 30A of the inspection processing unit 30, and the plurality of different types of subtraction images Xₛ₁, Xₛ₂, and Xₛ₃ are generated by executing the predetermined image process with the plurality of different image processing conditions based on the transmission image data Xᵢₐ, X_{ib} of the X-rays in the plurality of energy regions. By the operation means 42 of the inspection processing unit 30, at least one image of the total X-ray image Xₜₑ and the plurality of different types of subtraction images Xₛ₁, Xₛ₂, and Xₛ₃ is selected and set in a switchable manner as an image to be displayed and output. Therefore, the operator can easily and accurately grasp the situation of the inspection object W corresponding to the inspection result of the inspection object W and the situation of the particularly important inspection part or the target part for which an additional inspection or work may be required depending on the inspection result, from the display image Xᵢₚ, while ensuring the required inspection performance by the determination image X_{sc}.

As a result, it is possible to provide an X-ray inspection apparatus 1, an article inspection system, and an X-ray image forming apparatus, which have excellent inspection performance and workability.

### Second Embodiment

FIG. 8 illustrates a schematic configuration of an article inspection and processing system including an X-ray inspection apparatus according to a second embodiment of the present invention.

The article inspection and processing system 100 according to the present embodiment is provided with a front-stage conveyor 91 and a latter-stage conveyor 92 in front of and behind the X-ray inspection apparatus 1, which is an X-ray image forming apparatus, of the first embodiment described above, and is provided with a plurality of work booths 93A, 93B, 93C, and 93D along the latter-stage conveyor 92, and is an article processing system that is also an article inspection system and that can perform a post-process such as an additional inspection and processing.

That is, as illustrated in FIG. 8, the article inspection and processing system 100 includes the article transport unit 10 that transports the inspection object W (article) on a predetermined transport path, the X-ray inspection unit 20 that irradiates the inspection object W with X-rays to output the plurality of types of X-ray transmission image data X_{za} and X_{zb} which are X-ray line sensor images, an inspection processing unit 30 that executes an X-ray inspection by generating the X-ray transmission image data Xᵢₐ and X_{ib} in which the inspection object W is reflected based on the X-ray transmission image data X_{za} and X_{zb} from the X-ray inspection unit 20 and by generating the determination image X_{sc} which is the subtraction image, and outputs the total X-ray image Xₜₑ, the different types of subtraction images Xₛ₁, Xₛ₂, Xₛ₃, and the like which are candidate images of the inspection result OK/NG and the display image Xᵢₚ of the inspection object W, the operation display unit 40, and the plurality of post-process booths 93A, 93B, 93C, and 93D that are arranged in a staggered manner to be spaced apart from each other in the article transport direction (in the Db direction in FIG. 8) along the latter-stage conveyor 92 on the downstream side of the transport path, and also spaced apart from each other on both sides of the latter-stage conveyor 92 in a width direction (in the Da direction in FIG. 8).

In the article inspection and processing system 100, the inspection processing unit 30, which is an X-ray image forming apparatus, of X-ray inspection apparatus 1 includes the image processing block 30A that generates X-ray transmission image data, and the control block 30B that executes predetermined inspection control, display output control, and the like based on the X-ray transmission image data from the image processing block 30A.

In addition, although not illustrated in FIG. 8, the image processing block 30A has the transmission image data generation means 31, the transmission image data storage means 32, and the determination means 33, and the control block 30B has the determination means 33, the display control means 35, and the condition setting means 36 illustrated in FIG. 8, in the same manner as in the first embodiment (see FIG. 1).

The post-process booths 93A, 93B, 93C, and 93D include post-process display means 94A, 94B, 94C, and 94D including a plurality of displays, which can display and output at least one image among the total X-ray image Xₜₑ and the plurality of different types of subtraction images Xₛ₁, Xₛ₂, Xₛ₃, and the like generated by the image processing block 30A and selected and set by the operation means 42 of the operation display unit 40. In addition, in the vicinity of each of the post-process booths 93A, 93B, 93C, and 93D, sorting means capable of sorting and discharging the inspection object W on the latter-stage conveyor 92 into any of the post-process booths 93A, 93B, 93C, or 93D corresponding to each of sorting positions b1, b2, b3, or b4, for example, a plurality of flipper-type sorting devices 95A, 95B, 95C, and 95D (only main portions are illustrated) are provided.

In the present embodiment, in addition to the control block 30B that outputs the display image Xᵢₚ of the inspection target, which is at least one image among the inspection result OK/NG of the X-ray inspection unit 20, the total X-ray image Xₜₑ, the determination image X_{sc}, the plurality of different types of subtraction images Xₛ₁, Xₛ₂, Xₛ₃, and the like, the inspection processing unit 30 of the X-ray inspection apparatus 1 is provided with a sorting control block 30C that selects and sets an output destination of the display image Xᵢₚ of the inspection object W, and executes an operation of alternatively sorting and discharging the inspection object W to any one of the plurality of sorting devices 95A to 95D, according to a progress situation of the additional inspection and/or the additional processing (for example, remaining bone removal work) in the post-process booths 93A to 93D.

For example, when the inspection object W is sorted to the corresponding post-process booths 93A, 93B, 93C, or 93D by any of the sorting devices 95A to 95D, the sorting control block 30C measures a processing time until it is detected that the inspection object W after the processing, such as the additional inspection and/or the processing, is manually returned to the original sorting position b1, b2, b3, or b4, by a sensor, a switch, or the like (not illustrated) for detecting completion of work provided in each of the post-process booths 93A, 93B, 93C, or 93D. For example, the output destination of the display image Xᵢₚ of the inspection object W is selected and set according to a start time and a time length of the processing time, and the sorting and discharge operation is selectively executed by any of the plurality of sorting devices 95A to 95D.

In the article processing system of the present embodiment, at least one image of the total X-ray image Xₜₑ and the plurality of different types of subtraction images Xₛ₁, Xₛ₂, Xₛ₃, and the like, which are generated by the image processing block 30A of the inspection processing unit 30 and selected and set by the operation means 42, are selectively displayed and output by the post-process display means 94A to 94D of the post-process booths 93A to 93D. Therefore, a user who operates the operation means 42 can easily and accurately grasp a target part of the additional inspection or work in any of the corresponding post-process booths 93A to 93D based on the display image Xᵢₚ at a glance, and processing efficiency is improved.

In addition, corresponding to any one of the post-process display means 94A to 94D including the plurality of displays spaced apart from each other at least in the transport direction of the inspection object W, the inspection object W transported by the article transport unit 10 and a transport path of the latter-stage conveyor 92 is sorted in a space (additional process space) on a worktable of any one of the plurality of displays in the post-process booth 93A to 93D, in a transport order, by any one of the plurality of sorting devices 95A to 95D. Therefore, in the article inspection system of the present embodiment, since the total X-ray image Xₜₑ and the plurality of different types of subtraction images Xₛ₁, Xₛ₂, Xₛ₃, and the like are output as the display images Xᵢₚ to the post-process display means 94A to 94D of the post-process booths 93A to 93D, the target part of the additional inspection or the work in the post-process booths 93A to 93D can be easily and accurately grasped based on the display images Xᵢₚ, and the processing efficiency in the post-process booths 93A to 93D can be improved.

Further, in the article processing system, since the plurality of displays of the post-process display means 94A to 94D are spaced apart from each other at least in the article transport direction, the inspection object W that is determined to require the additional inspection or the processing (for example, a dedicated inspector visually inspects for any small bones, and if any remain, the inspector removes the bones for work) by the determination means 33 on the transport path passing from the article transport unit 10 to the latter-stage conveyor 92 is sorted and transported to any of the post-process booths 93A to 93D, it is possible to secure a sufficient processing time for the additional inspection or processing and to execute the stable additional inspection or processing.

In this manner, in the present embodiment, in the X-ray inspection apparatus 1 having the function of the X-ray image forming apparatus, it is possible to enable the operator to easily and accurately grasp the situation of the inspection object related to the inspection or the work while improving the inspection performance such as the foreign matter detection, and it is possible to realize the article processing system having high processing efficiency.

In the first embodiment described above, the X-ray inspection apparatus 1 is described as the X-ray image forming apparatus according to the present invention and the article inspection system including the sorting device at the latter stage of the X-ray inspection apparatus 1, and in the second embodiment, the article processing system including the plurality of work booths 93A to 93D provided with the plurality of sorting devices 95A to 95D as sorting means at the latter stage of the X-ray inspection apparatus 1 is described, and a form or disposition of the post-process work booth is optional.

In addition, the conditions for the control of the display output of the display image Xᵢₚ or the sorting and discharge of the inspection object W to the plurality of work booths 93A to 93D are also optional, and as the conditions for such control, for example, as described in JP-A-2017-138193, a sorting rule including a work code, a work time, the number of works, and the like of the user may be managed, maintained, and updated in a memory table format.

As described above, the X-ray inspection apparatus, the article inspection system, and the X-ray image forming apparatus according to the present invention can provide an X-ray inspection apparatus, an article inspection system, and an X-ray image forming apparatus with which an operator easily and accurately grasps a situation of an inspection object related to an inspection or work while improving inspection performance such as foreign matter detection. The present invention is useful for an X-ray inspection apparatus, an article inspection system, and an X-ray image forming apparatus in general, capable of generating an X-ray image appropriate for a purpose such as an article inspection based on transmission image data of X-rays in a plurality of different energy regions.

### DESCRIPTION OF REFERENCE NUMERALS AND SIGNS

1: X-ray inspection apparatus (X-ray image forming apparatus)
10: article transport unit
11: belt (transport belt)
11a: transport path (portion of transport path)
12, 13: roller
20: X-ray inspection unit (inspection unit)
21: X-ray generator (X-ray generation means)
22: X-ray detector (X-ray detection means, transmission image data generation unit)
22₁ to 22_{N}: sensor (photon detection type sensor)
30: inspection processing unit (inspection unit, image processing unit, display image processing unit)
30A: image processing block
30B: control block
30C: sorting control block
31: transmission image data generation means (transmission image data generation unit)
32: transmission image data storage means (display image generation means)
33: determination means
34: display image generation means
35: display control means (execution means of display image process, execution means of plurality of types of subtraction processes)
36: condition setting means
40: operation display unit
41: display means
42: operation means (operation input means, selection operation means)
51₁ to 51_{N}: A/D conversion unit
52₁ to 52_{N}: wave peak value detection unit
53₁ to 53_{N}: region determination unit
54₁ to 54_{N}: region-by-region accumulation unit
55: transmission image data output unit
60: first operation display screen
61: inspection state display region
62: common information display region
63: inspection target image display region (figure display region)
64: inspection information display region
65: operation button display region
65a: setting and adjustment button
66: function selection and setting operation window
70: second operation display screen (display image selection screen)
71: inspection state display region
72: common information display region
73: preview image display region
73a, 73b: candidate image
74: selection input display region
74a: radio button
74b: scroll button
75a: update button
75b: cancel button
75c: operation button
83: display screen selection setting window
83a, 83b: candidate image
83c, 83d: candidate image (emphasized selection image)
83e, 83f: candidate image
91: front-stage conveyor (portion on upstream side of transport path)
92: latter-stage conveyor (portion on downstream side of transport path)
93A, 93B, 93C, 93D: post-process booth (post-process work booth, and worktable)
94A, 94B, 94C, 94D: post-process display means (display)
95A, 95B, 95C, 95D: sorting device (sorting means)
100: article inspection and processing system (article inspection system, article processing system)
b1, b2, b3, b4: sorting position
L₁, L₂, L₃: region boundary value of pulse signal level
R₁, R₂: energy region (division on high-energy side, division of pulse signal level)
R₃, R₄: energy region (division on low-energy side, division of pulse signal level)
Xᵢₐ: X-ray transmission image (X-ray transmission image data in first energy region)
X_{ib}: X-ray transmission image (X-ray transmission image data in second energy region)
Xᵢₚ: display image (display image data)
Xₛ₁, Xₛ₂, Xₛ₃: different types of subtraction images (display image data)
X_{sc}: determination image (determination subtraction image data; display data)
Xₜₑ: total image data (display image data)
X_{za}: first X-ray transmission image data (X-ray line image data)
X_{zb}: second X-ray transmission image data (X-ray line image data)

What is claimed is:

1. An X-ray inspection apparatus comprising:
an inspection unit that detects X-rays transmitted through an inspection object in a plurality of energy regions, and inspects the inspection object by using a determination image generated by executing a predetermined image process on at least two pieces of X-ray transmission image data corresponding to at least two energy regions;
display means for displaying an inspection result of the inspection unit;
display image generation means for generating a display image by executing a display image process different from the image process for generating the determination image, on the X-ray transmission image data; and
display control means for causing the display means to display the inspection result and the display image.

2. The X-ray inspection apparatus according to claim 1,
wherein the determination image is a subtraction image obtained by performing a subtraction process on the transmission image data of the X-rays in the plurality of energy regions, which are transmitted through the inspection object, and
the display image is an image in which an image brightness of the inspection object in the image has a higher contrast than an image brightness of the inspection object in the determination image.

3. The X-ray inspection apparatus according to claim 1, further comprising:
operation input means for inputting request information according to an operation input of a user,
wherein the display image generation means generates the display image as a plurality of different images in which the same target object is reflected, by executing a plurality of types of image processes set in advance on X-ray transmission image data of a specific energy region among the plurality of energy regions, based on the request information from the operation input means.

4. The X-ray inspection apparatus according to claim 3,
wherein the display image generation means executes a plurality of types of image processes stored in advance to generate a total X-ray image corresponding to the X-ray transmission image data including the plurality of energy regions, and performs a subtraction process on the X-ray transmission image data of the plurality of energy regions under a plurality of different image processing conditions to generate a plurality of different types of subtraction images, and
the operation input means performs an operation input of requesting a display output of any one image or a plurality of images among the total X-ray image and the plurality of different types of subtraction images and an operation input of requesting a change setting of the display output.

5. The X-ray inspection apparatus according to claim 4,
wherein the plurality of different types of subtraction images are subtraction images in which article-affected brightness variation of the inspection object in the image are different from each other according to the plurality of different image processing conditions.

6. An article inspection system comprising:
the X-ray inspection apparatus according to claim 1;
a transport device that transports an article on a predetermined transport path; and
a post-process booth disposed on a downstream side of the transport path,
wherein an inspection unit of the X-ray inspection apparatus has an X-ray detector that detects X-rays transmitted through the article on the transport path, and outputs a detection signal, and
display image generation means of the X-ray inspection apparatus outputs a display image to post-process display means installed in the post-process booth.

7. An X-ray image forming apparatus comprising:
a transmission image data generation unit to which a detection signal of X-rays transmitted through an article is input and which generates X-ray transmission image data in a plurality of different energy regions;
an image processing unit that executes a predetermined image process on the X-ray transmission image data in the plurality of energy regions to generate at least a subtraction image of the X-ray transmission image data; and
an image output unit that causes display means to output the image generated by the image processing unit,
wherein the image processing unit includes display image generation means for generating a total X-ray image corresponding to the X-ray transmission image data including the plurality of energy regions, and executing the predetermined image process on the X-ray transmission image data in the plurality of energy regions under a plurality of different image processing conditions to generate a plurality of different types of subtraction images as the subtraction image, and
the image output unit includes selection operation means for selecting and setting at least one image of the total X-ray image and the plurality of different types of subtraction images generated by the display image generation means in a switchable manner as an image to be displayed and output.

8. An article processing system comprising:
the X-ray image forming apparatus according to claim 7;
a transport device that transports an article on a predetermined transport path; and
a post-process booth disposed on a downstream side of the transport path,
wherein a transmission image data generation unit of the X-ray image forming apparatus has an X-ray detector that detects X-rays transmitted through the article on the transport path, and outputs a detection signal, and
the post-process booth has post-process display means for displaying and outputting at least one of a total X-ray image and a plurality of different types of difference images, which are generated by the image processing unit and selected and set by the selection operation means.

9. The article processing system according to claim 8,
wherein the post-process display means is configured to include a plurality of displays spaced apart from each other at least in a transport direction of the article, and
the post-process booth is provided with sorting means for sorting the article transported on the transport path in an additional process space corresponding to any one of the plurality of displays, in a transport order.
